(19) United States
(12) Patent Application Publication
(10) Pub. No.: US 2009/0145681 A1
(43) Pub. Date: Jun. 11, 2009

(54) Actuator

(75) Inventors: Takeki Hayashi, Aichi-ken (JP); Hajime Kitte, Aichi-ken (JP); Masashi Aoki, Aichi-ken (JP); Hiroyuki Takahashi, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/314,152

(22) Filed: Dec. 4, 2008

(30) Foreign Application Priority Data
Dec. 7, 2007 (JP) 2007-317216

(51) Int. Cl. B60R 21/34

(52) U.S. Cl. 180/274

(57) ABSTRACT

The invention provides an actuator A configured as an actuator in which a piston 38 disposed in a cylinder 21 is moved together with a supporting rod 45 connected to the piston 38 by introducing a working fluid G into the cylinder 21 and including a locking mechanism R for restricting a reverse movement of the supporting rod 45 which has moved forwards. The locking mechanism R includes a locking pin 43 adapted to project from an outer circumferential surface of the piston 38 which extends around an axis thereof, a flow path 40 which allows a working fluid G which flows into the cylinder 21 to flow, and a locking surface 25 for locking the locking pin 43 and is made to cause the locking pin 43 to project from the outer circumferential surface of the piston 38 by making use of the pressure of the working fluid G which is allowed to flow into an accommodating recessed portion 39 of the locking pin 43 via a flow path 40.

### BACKGROUND OF THE INVENTION

1. Field of the Invention

The present invention relates to an actuator for use in an automotive safety system and more particularly, for example, to an actuator which is used in a pedestrian protection system to lift up a hood panel which receives a pedestrian as an object to be protected.

2. Description of the Related Art

Conventionally, as an actuator for an automobile safety system installed on a vehicle, there has existed an actuator for raising a rear end side of a hood panel so that the hood panel can receive a pedestrian by itself by making use of energy absorption occurring when the hood panel is plastically deformed. Specifically, as a conventional actuator, there has been an actuator which is configured as a piston cylinder type actuator in which a piston disposed in a tubular cylinder is moved together with a supporting rod which is connected to the piston by introducing a working fluid into the cylinder and which has a locking mechanism for restricting a reverse movement of the supporting rod which has moved forwards (for example, refer to Patent Document 1). In the conventional actuator, as a locking mechanism, a locking mechanism was used which was made up of a holder which was provided in such a manner as to project from the cylinder along a direction which intersected an axis of the cylinder at right angles and a locking piece which was held on the holder via a biasing device. In this locking mechanism, when in operation, the locking pieces was moved in such a manner as to project into the cylinder by virtue of a biasing force of the biasing device, so as to restrict a reverse movement of the supporting rod by the locking piece.

Patent Document 1: JP-A-2002-29367

In the conventional actuator, however, since the locking mechanism is provided in such a manner as to project largely by an amount by which the locking piece itself and the biasing device are added from the cylinder in the direction which intersects the axis of the cylinder at right angles, the locking mechanism becomes largely bulky in the direction which intersects the axis of the cylinder at right angles, and thus, there has still been room for improvement in making compact the actuator itself.

### SUMMARY OF THE INVENTION

The invention has been made with a view to solving the problem and an object thereof is to provide an actuator which can be fabricated compact even though the actuator includes a locking mechanism for preventing a reverse movement of a supporting rod after it has been put in operation.

According to an aspect of the invention, there is provided an actuator adapted to be used in an automotive safety system, and configured as a piston cylinder type actuator in which a piston disposed in a tubular cylinder is moved together with a supporting rod connected to the piston by introducing a working fluid into the cylinder,

including a locking mechanism for restricting a reverse movement of the supporting rod which has moved forwards, and

configured in such a manner that the supporting rod which projects from a distal end wall portion of the cylinder is connected to a receiving member for receiving an object to be protected, wherein

the supporting rod is provided in such a manner as to be plastically deformed so as to absorb kinetic energy of the object to be protected when the receiving member receives the object to be protected after the supporting rod has moved forwards, wherein

the locking mechanism includes:

a locking pin adapted to be accommodated and held within the piston while being restricted from a movement along an axial direction of the piston when the locking pin moves forwards in such a manner that a distal end portion side of the locking pin projects along a direction which intersects the axial direction of the piston at right angles from an outer circumferential surface of the piston which extends around an axis of the piston with a proximal portion side thereof accommodated within the piston;

a flow path formed in the piston in such a manner as to allow the working fluid which flows into the cylinder to flow as far as an accommodating portion where the proximal portion side of the locking pin is accommodated; and

a locking surface provided in a position on an inner circumferential surface of the cylinder where the piston is disposed after the piston has moved forwards and adapted to lock the locking pin which is caused to project from the piston at the distal end portion side thereof so as to restrict a reverse movement of the supporting rod, and

when in operation, the proximal end portion side of the locking pin is moved in such a manner as to project from the outer circumferential surface of the piston by making use of a pressure produced by the working fluid which has been allowed to flow into the accommodating portion of the locking pin via the flow path.

In the actuator according to the aspect of the invention, when in operation, when the working fluid is introduced into the cylinder to fill it, the piston accommodated in the cylinder is pushed by the working fluid and then moves forwards together with the supporting rod. As this occurs, in the actuator of the invention, the working fluid flows into the accommodating portion which the locking pin is accommodated via the flow path provided in the piston at the same time as the piston is pushed by the working fluid, and the locking pin receives the pressure of the working fluid, whereby the piston moves forwards together with the supporting rod in such a state that a distal end face of the locking pin so pressed is kept in sliding contact with an inner circumferential surface of the cylinder at all times. Thereafter, in the event that the piston continues to move forwards until the locking pin accommodated in the piston is disposed in a position confronting the locking surface provided on the inner circumferential surface of the cylinder, due to the locking pin receiving the pressure of the working fluid which has been introduced into the accommodating portion of the locking pin via the flow path, the locking pin is momentarily caused to project from the accommodating portion and the distal end portion side of the locking pin comes to be locked on the locking surface. Then, since the locking pin is disposed in such a manner as to straddle between the accommodating portion and the locking surface with the proximal portion side accommodated in the accommodating portion in such a manner as be restricted from moving along the axial direction of the piston, the reverse movement of the supporting rod which has moved forwards can be restricted, whereby when the object to be protected is received by the receiving member after the supporting rod has moved forwards, the supporting rod is made to be plastically deformed so as to absorb the kinetic energy of the object to be protected. Furthermore, in the actuator of the invention, since the locking mechanism for restricting the reverse movement of the supporting rod which has moved forwards is made up of the locking pin accommodated within the piston and the locking surface formed on the inner circumferential surface side of the cylinder, the locking mechanism is provided in such a manner as not to project from the cylinder to the outside thereof, whereby the external shape of the actuator can be formed into the substantially circular cylindrical shape, and hence, the actuator can be made as compact as possible.

Consequently, the actuator of the invention can be fabricated compact even though the actuator includes the locking mechanism which can prevent the reverse movement of the supporting rod after the supporting rod has moved forwards.

In addition, in the actuator of the invention, since the locking pin is configured in such a manner as to be pushed outwards by making use of the working fluid, the necessity can be obviated of providing separately a drive source for actuating the locking mechanism, and hence, an increase in number of parts involved can be prevented while suppressing the complication of the configuration of the actuator.

In the actuator of the invention, a large diameter portion which is made larger in diameter than a sliding portion along which the piston slides when it moves forwards is provided in a position where the locking pin projects after the piston has moved forwards, and a stepped surface from the sliding portion at the large diameter portion is preferably made as the locking surface.

In the event that the actuator is configured as has been described above, compared with a case where a recessed portion through which the locking pin can be passed is provided on the inner circumferential surface of the cylinder so as to function as the locking surface, the locking surface can preferably be formed in an easier fashion.

Furthermore, in the actuator configured as described above, in the event that locking pins like the locking pin are made to be provided at a plurality of portions which are disposed at substantially equal intervals along the direction extending around the axis of the piston, since the locking pins are allowed to be locked on the locking surface over the full circumferential area thereof along the direction which extends around the axis of the cylinder, the projecting state of the supporting rod can preferably be stabilized.

In addition, in the actuator configured as described above, in the event that a movement preventing wall for preventing a movement of the locking pin towards a center of the piston is formed at the accommodating portion, the locking pin can preferably be prevented from moving towards the center of the piston more than required.

Furthermore, in the actuator configured as described above, in the event that a return preventive device for preventing a return of the projecting locking pin is provided on a circumference of the locking pin in the accommodating portion, the locking pin which has projected from the accommodating portion can be prevented from returning to the accommodating portion side as a result of striking against the inner circumferential surface of the cylinder, whereby the projecting state of the locking pin can preferably maintained in a stable fashion.

### BRIEF DESCRIPTION OF THE DRAWINGS

FIG. 1 is a perspective view of a vehicle in which a pedestrian protection system which utilizes an actuator according to an embodiment of the invention is installed.

FIG. 2 is a partial enlarged plan view of the vehicle in which the pedestrian protection system which utilizes the actuator of the embodiment is installed.

FIG. 3 is a schematic vertical sectional view of the pedestrian protection system of the embodiment along a longitudinal direction of the vehicle, which corresponds to a sectional view taken along the line III-III in FIG. 2.

FIG. 4 is a schematic vertical sectional view of the pedestrian protection system of the embodiment when the system is activated.

FIG. 5 is a schematic view showing a state in which a supporting rod of the actuator of the embodiment is plastically deformed.

FIG. 6 is a schematic view showing a state in which the supporting rod of the actuator of the embodiment is plastically deformed, the state of plastic deformation shown being developed further than the state shown in FIG. 5.

FIG. 7 is schematic vertical sectional views of the actuator of the embodiment; FIG. 7A showing a state resulting before activation, FIG. 7B showing a state resulting when the activation has been completed.

FIG. 8 is schematic enlarged vertical sectional views showing a portion where a locking mechanism of the actuator of the embodiment is provided; FIG. 8A showing a state resulting before activation, FIG. 8B showing a state resulting when the activation has been completed.

FIG. 9 is schematic enlarged cross-sectional views showing the portion of the locking mechanism of the actuator of the embodiment is provided; FIG. 9A showing a state resulting before activation, FIG. 9B showing a state resulting when the activation has been completed.

FIG. 10 is a schematic enlarged vertical sectional view showing a modified example of a locking mechanism in the actuator of the embodiment.

FIG. 11 is a schematic view showing a modified example in which the actuator of the embodiment is applied to a knee protection system.

### DESCRIPTION OF THE PREFERRED EMBODIMENTS

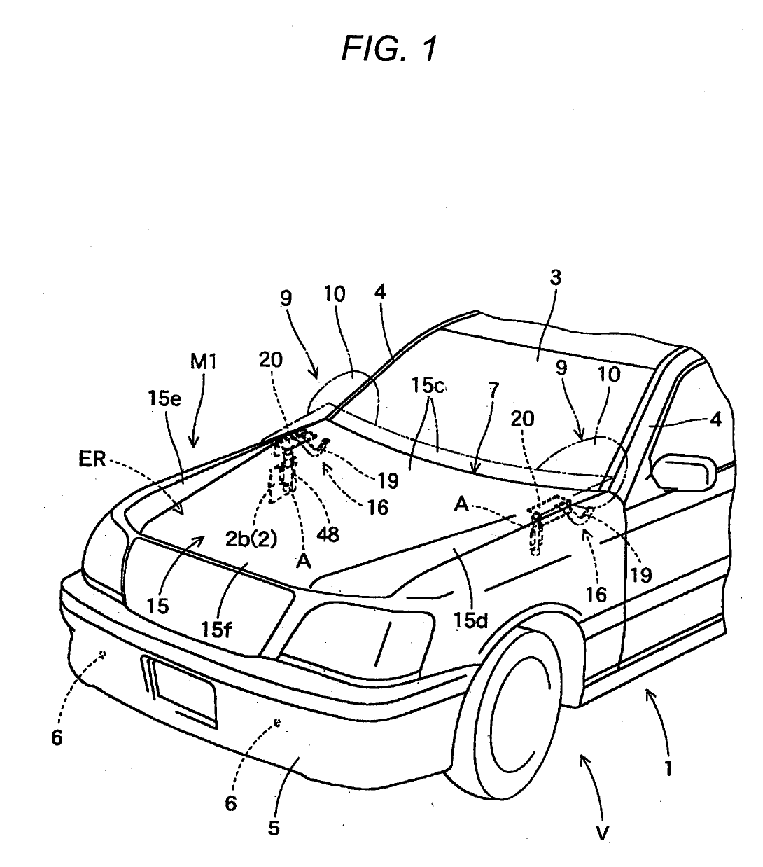

Hereinafter, an embodiment of the invention will be described based on the accompanying drawings. An actuator A according to an embodiment of the invention is, as is shown in FIGS. 1 to 3, an actuator for use in an uplift unit U in a pedestrian protection system which is an automotive safety system installed on a vehicle V. This uplift unit U is configured in such a manner as to uplift a rear end 15c of a hood panel 15 when the actuator A is put in operation. In addition, the actuator A of the embodiment is provided below a position lying in the vicinity of the rear end 15c of on the hood panel 15 of the vehicle V. The pedestrian protection system M is made up of the uplift units U for uplifting the rear end 15c of the hood panel 15 which acts as a receiving member for receiving a pedestrian and air bag units 9 each having an air bag 10 for protecting a pedestrian from a collision against a front pillar 4.

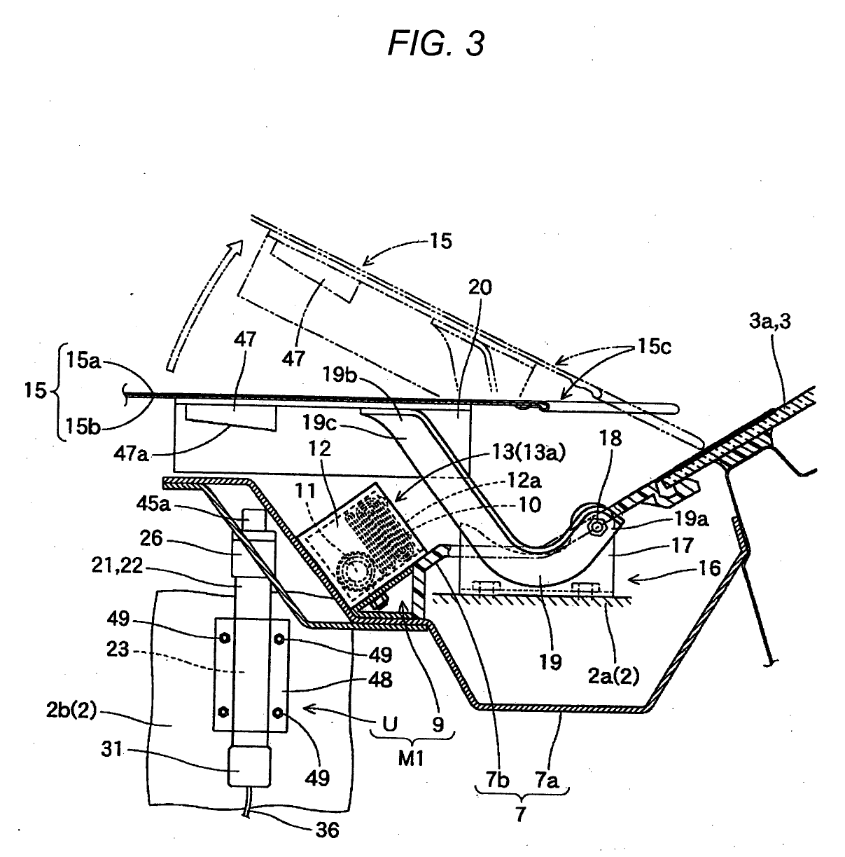

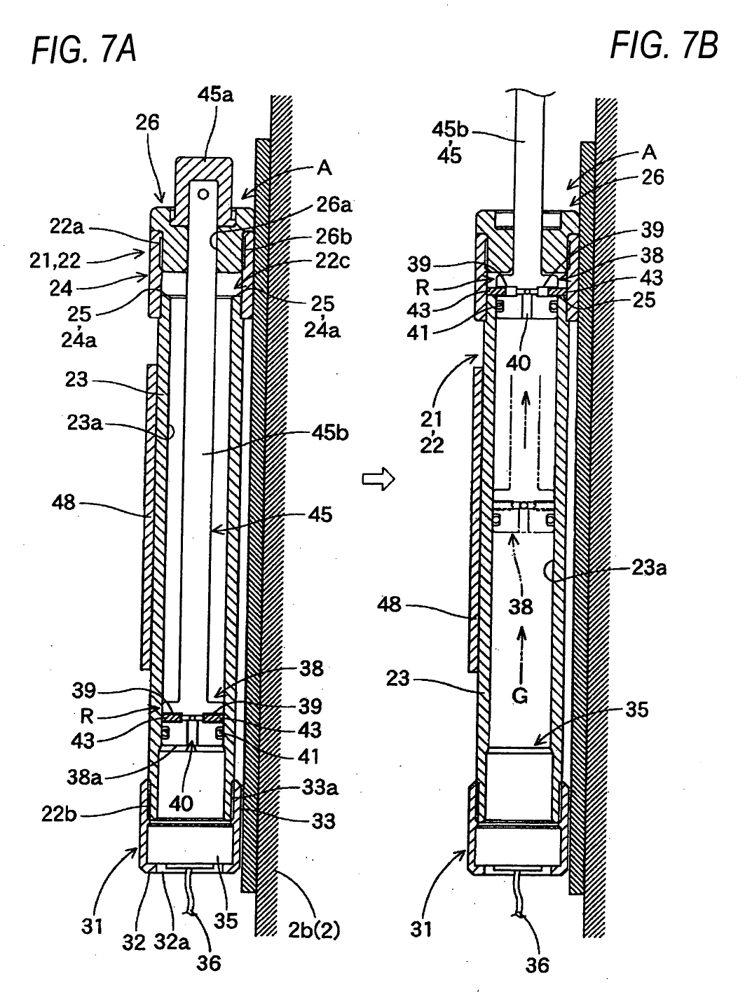

In addition, as is shown in FIG. 1, sensors 6 are provided on a front bumper 5 of the vehicle V for detecting or predicting a collision of a pedestrian as an object to be protected with the vehicle V. In addition, when an activation circuit, not shown, into which signals from the sensors 6 are made to be inputted detects or predicts a collision of a pedestrian with the vehicle V based on signals from the sensors 6, inflators 11 (refer to FIG. 3) of the air bag units 9 and gas generators 35 (refer to FIG. 7) as drive sources in the actuators A of the uplift units U are made to be activated.

As is shown in FIGS. 1 to 3, the hood panel 15 is such as to be provided in such a manner as to cover above an engine room ER of the vehicle V and is connected to a body 1 of the vehicle V via hinge portions 16 which are disposed in the vicinity of the rear end 15c on both left and right side edges thereof I such a manner as to be opened and closed at a front end of the hood panel 15. The hood panel 15 is made of a sheet of aluminum (aluminum alloy) and is made up of an outer panel 15a lying on an upper side and an inner panel 15b which lies on a lower side and has a strength which is higher than that of the outer panel 15a. The hood panel 15 is made to be plastically deformed in such a manner as to absorb the kinetic energy of a pedestrian when the pedestrian is received by the hood panel 15. In addition, in this embodiment, with a view to providing a large space at an upper portion in the engine room ER in order to increase the amount of deformation when the hood panel 15 is plastically deformed, the rear end 15c of the hood panel 15 is uplifted by activating the actuators A of the uplift units U. In addition, the uplift unit U of this embodiment also functions to provided a large space S between a cowl 7 and the rear end 15c of the hood panel 15 for the air bag 10 to project therethrough.

The hinge portions 16 are provided at the rear end 15c of the hood panel 15 on a left edge 15d and a right edge 15e (refer to FIG. 1) and are each made up of a hinge base 17 which is fixed to a mounting flange 2a which is connected to a hood ridge reinforcement 2 on the body 1 side and a hinge arm 19 which is fixed to the hood panel 15 side (refer to FIG. 3). As is shown in FIG. 3, each hinge arm 19 is made into a shape which results when an angle iron member made of metal is curved into a substantially semi-arc shape in such a manner as to project while being oriented downwards. A proximal end portion 19a which lies on the hinge base 17 side is rotatably connected to the hinge base 17 by making use of a support shaft 18, and a distal end 19b which lies apart from the proximal end portion 19a is joined to a mounting bracket 20 by making use of welding or the like. Each support shaft 18 is provided in such a manner that its axial direction extends along a transverse direction of the vehicle V. Because of this, when opening the hood panel 15, the front end 15f side (refer to FIG. 1) of the hood panel 15 is raised from a position indicated by solid lines to a position indicated by chain double-dashed lines in FIG. 3 as the distal end sides of the left and right hinge arms 19 are raised about the left and right support shafts 18 as rotating centers so that the hood panel 15 is opened at the front end 15f side thereof.

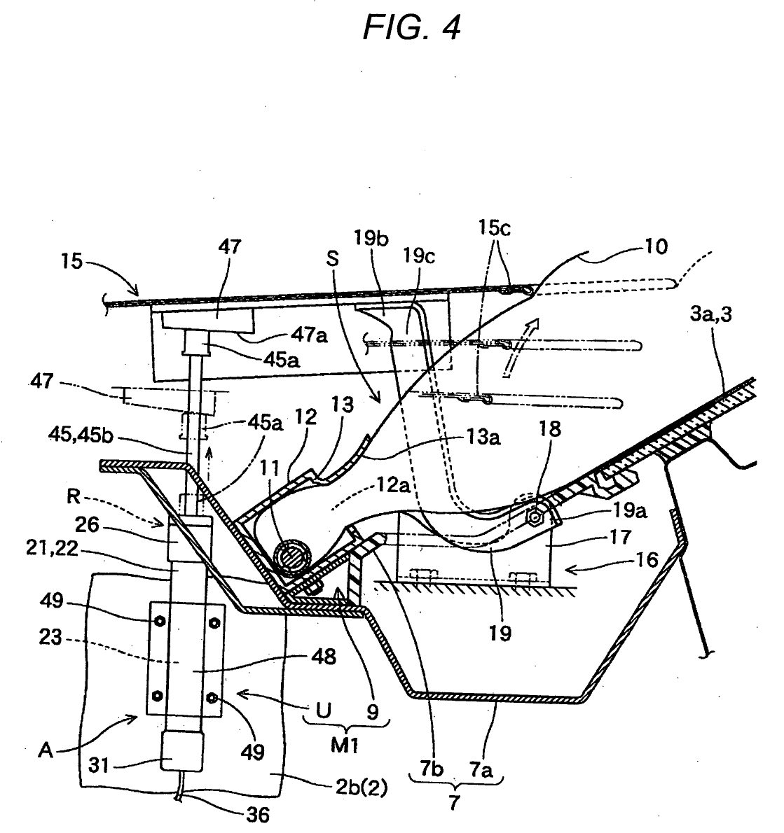

In addition, a portion of the hinge arm 19 which lies in the vicinity of the distal end 19b is made as a plastically deformable portion 19c which is plastically deformed when the rear end 15c of the hood panel 15 is pushed up by a supporting rod 45 as a result of the actuator A being put in operation (refer to FIG. 4). Incidentally, the front end 15f side of the hood panel 15 is dislocated in no case from the body 1 side by a latch mechanism which locks on a striker which is disposed on the front end 15f side of the hood panel 15 when the rear end 15c of the hood panel 15 is raised and which is disposed at the front end 15f when the hood panel 15 is closed in a normal fashion.

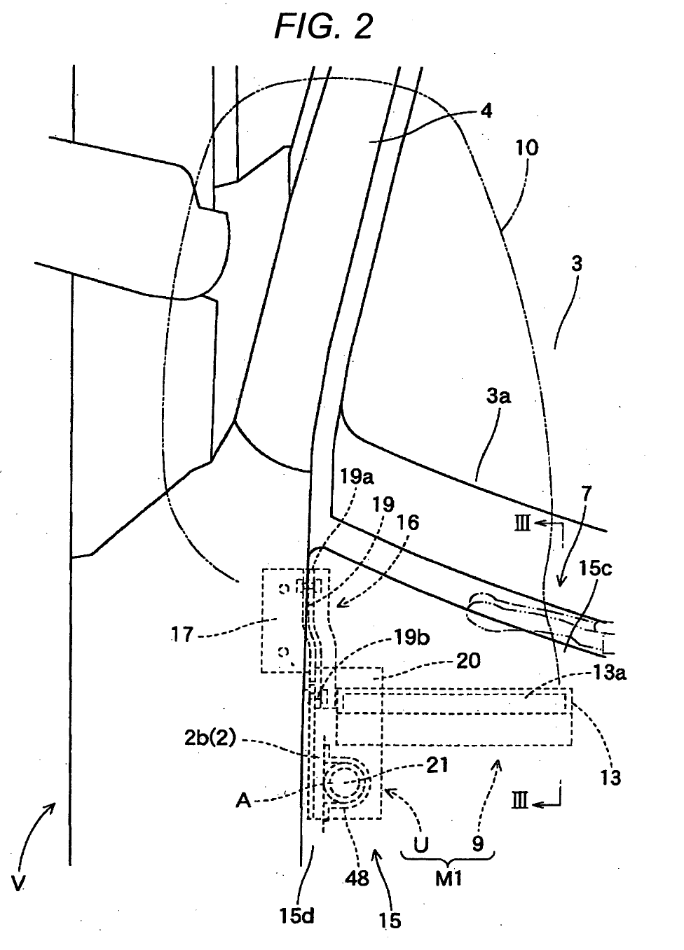

As is shown in FIGS. 2, 3, the air bag units 9 are each made up of the air bag 10, an inflator 11 for supplying an inflation gas into the air bag 10, a case 12 which accommodates therein the air bag 10 and the inflator 11 and an air bag cover 13 which covers the case 12 which accommodates therein the air bag and the inflator 11 in such a manner as to be opened and are installed in portions of the cowl 7 which lies substantially below the left edge 15d and right edge 15e of the hood panel 15 at the rear end 15c thereof. In the air bag unit 9, when the rear end 15c of the hood panel 15 is uplifted as a result of the uplift unit U being activated, the inflator 11 operates to cause the air bag 10 to project from the space S defined between the rear end 15c of the hood panel 15 and the cowl 7, and the inflation gas is supplied into the folded air bag 10 (refer to FIG. 4). In addition, when the inflation gas is introduced into the air bag 10, the air bag 10 push opens a door portion 13a of the air bag cover 13 which covers an opening 12a at the rear of the case 12 and then starts to deployed to be inflated. Thus, the air bags 10 which have been so deployed to be inflated come to cover front sides of left and right front pillars 4, 4 (refer to FIG. 1).

In addition, as is shown in FIG. 3, the cowl 7 is made up of a highly rigid cowl panel 7a which lies on the body 1 and a cowl louver 7b which lies above the cowl panel 7a. The cowl louver 7 is provided in such a manner that a rear end side thereof becomes consecutive to a lower portion 3a side of a windshield 3. In addition, as is shown in FIGS. 1, 2, the front pillars 4, 4 are provided at the left and right of the windshield 3, respectively.

As is shown in FIGS. 3 to 6, the uplift unit U is made up of the actuator A and a receiving seat 47 provided on the hood panel 15 side. The actuators A are provided, as is shown in FIG. 1, below the left and right side edges of the hood panel 15 at the rear end thereof in such a manner as to confront, respectively, the two portions on the hood panel 15 where the left and right hinge portions 16 are disposed. As is shown in FIG. 7, each of the actuators A is made as a piston cylinder type actuator in which gas G generated when the gas generator 35 is activated is used as a drive source, and a piston 38 is accommodated in a circularly tubular cylinder 21. The receiving seat 47 is attached to a position on a lower surface of the rear end 15c of the hood panel 15 where the mounting bracket 20 is provided and is made to receive by a lower surface 47a thereof a head portion 45a at a distal end of the supporting rod 45 of the actuator A which is designed to move upwards.

As is shown in FIGS. 2 to 5, the actuator A of the embodiment is held by a mounting bracket 48 having a U-shaped cross section which is fastened with bolts 49 to a mounting flange 2b which is connected to the hood ridge reinforcement 2 and is provided below on each of the left and right side edges of the hood panel 15 at the rear end 15c thereof. In addition, as is shown in FIGS. 7 to 9, each actuator A is made up of the cylinder 21, the piston 38 which is accommodated slidably within the cylinder 21, the supporting rod 45 which is connected to the piston 38 and a locking mechanism R for restricting a reverse movement (a descending movement in this embodiment) of the supporting rod 45 which has moved forwards (a rising movement in this embodiment).

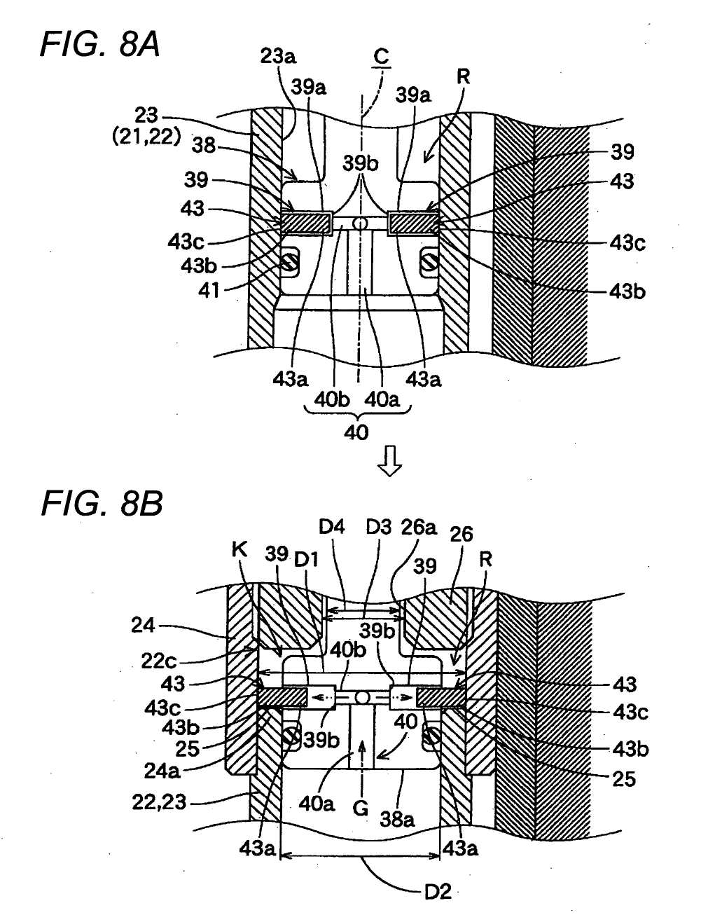

As is shown in FIG. 7, the cylinder is made up of a circularly tubular main body 22 and caps 26, 31 which are fixed to upper and lower ends of the main body 22. The main body 22 includes a sliding portion along which the piston 38 is allowed to slide when it moves forwards (when it moves upwards), as well as a recessed portion 22c which is provided on an inner circumferential surface of an upper end side of the main body 22 which constitutes an upper end side of the sliding portion 23 in such a manner as to be recessed circumferentially along a full circumference of the inner circumferential surface. This recessed portion 22c is such as to be formed in a position where locking pins 43, which will be described later, of the locking mechanism R project after the piston 38 has moved forwards (after the piston 38 has moved upwards), and in the case of the embodiment, the portion where the recessed portion 22 is provided is disposed above the sliding portion 23 and is made up of a large diameter portion 24 whose inside diametrical dimension D1 is made larger than an inside diametrical dimension D2 of the sliding portion 23 (refer to FIG. 8B). More specifically, in the case of the embodiment, the larger diameter portion 24 is made up of a separate member whose inside diametrical dimension is made larger than a member which makes up the sliding portion 23 and is made integral with the member which makes up the sliding portion 23 through welding or the like. In addition, a stepped surface 24a from the sliding portion 23 at the large diameter portion 24 (more specifically, an upper end face of the sliding portion 23 which is an end face of the sliding portion 23 which faces in a direction in which the piston moves forwards) locks lower sides (sides facing in a direction in which the piston reverses) of distal end portions 43b of the projecting locking pins 43 and thus constitutes a locking surface 25 which restricts a descending movement of the piston 38 (the supporting rod 45).

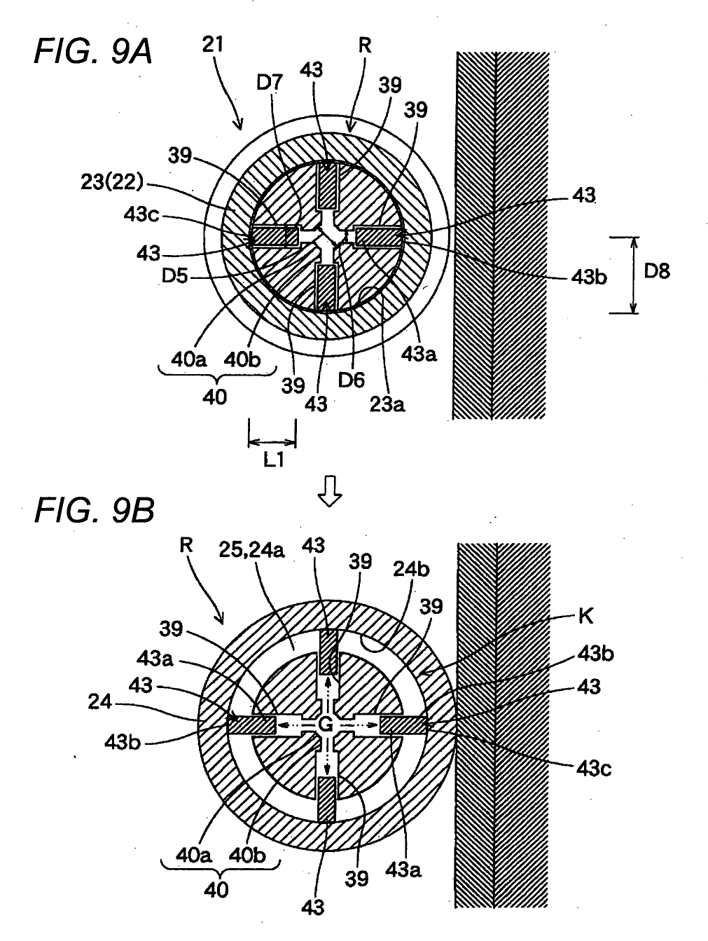

The cap 26 disposed at the upper end side of the main body 22 is such as to make up a distal end wall portion of the cylinder 21 and is formed into a substantially circular cylindrical shape. The cap 26 includes a through hole 26a which is provided in a center of the cap 26 in such a manner that a shaft portion 45b of the supporting rod 45 is passed therethrough and an external thread 26b on which an internal thread 22a provided on an inner circumferential side of the upper end of the main body 22 of the cylinder 21 (an inner circumferential side of the large diameter portion 24) is screwed. The cap 26 is attached to the main body 22 by screwing the external thread 26b in the internal thread 22a in such a state that the shaft portion 45b of the supporting rod 45 is passed through the through hole 26a. In the case of the embodiment, the through hole 26a is configured to have an inside diametrical dimension D3 which is made slightly larger than an outside diametrical dimension D4 of the shaft portion 45b so as to define a gap between the shaft portion 45b and the cap 26 itself so that gas G accumulated within a space K (refer to FIGS. 8B, 9B) defined from accommodating recessed portions 39 formed in the piston 38 to the large diameter portion 24 and the cap 26 until the locking pins 43 are locked on the locking surface 25 when the piston 38 moves upwards can be discharged to the outside (refer to FIG. 38). The cap 31 disposed at the lower end side of the main body 22 is made up of a proximal end wall portion 32 which is disposed in such a manner as to close the lower end of the main body 22 and a substantially circularly cylindrical circumferential wall portion 33 which extends upwards from an outer circumferential edge of the proximal end wall portion 32. A through hole 32a is formed in the proximal end wall portion 32 in such a manner that the gas generator 35 can be passed therethrough, and the gas generator 35 is attached to the proximal end wall portion 32 by making use of a circumferential edge of the through hole 32a and a lower end side portion of the circumferential wall portion 33. The circumferential wall portion 33 includes on an inner circumferential surface of an upper end side thereof an internal thread 33a which screws on an external thread 22b provided on an outer circumferential side of the lower end of the main body 22 of the cylinder 21, and the cap 31 is attached to the main body 22 by screwing the internal thread 33a on the external thread 22b in such a state that the gas generator 35 is attached to the proximal end wall portion 32.

A micro gas generator is used as the gas generator 35. A lead wire 36 is connected to a lower end face of the gas generator 35, so that electrical signals from a control circuit, not shown, are inputted into the gas generator 35 through the lead wire 36 (refer to FIG. 7). When electrical signals from the control circuit, not shown, are inputted thereinto, the gas generator 35 burns explosives incorporated therein to generate a combustion gas, so that the gas (combustion gas) G so generated is supplied to a lower surface side of the piston 38 residing within the cylinder 21 as a working fluid.

The piston 38 is made into a substantially circular cylindrical shape having an outside diametrical dimension which allows the piston 38 to slide on the sliding portion 23 of the cylinder 21 and includes the accommodating recessed portions 39 (the accommodating portion) which can accommodate therein the locking pins 43 which make up the locking mechanism R and a flow path 40 which makes up the locking mechanism R and introduces the gas G which flows into the cylinder 21 to the accommodating recessed portions 39 where the locking pins 43 are accommodated.

The accommodating recessed portion 39 is such as to accommodate the locking pin 43 in such a manner that the locking pin 43 can project along a direction which intersects an axis of the piston 38 at right angles when the gas G flows thereinto, and in the case of the embodiment, specifically, as is shown in FIGS. 8 and 9, the accommodating recessed portion 39 is formed to be recessed into a substantially circular cylindrical shape along the direction which intersects the axis of the piston 38 at right angles from an outer circumferential surface of the piston 38 which extends around the axis thereof in such a manner as to accommodate therein the locking pin 43 in a substantially vertically central position of the piston. In the case of the embodiment, a plurality of accommodating recessed portions 39 are provided at a plurality of portions on the piston 38 which are disposed circumferentially at substantially equal intervals in such a manner as to match a plurality of locking pins 43 provided as will be described later. More specifically, four accommodating recessed portions 39 are provided radially about a center axis C of the piston 38 (refer to FIG. 9).

In the case of the embodiment, the flow path 40 is made up of a vertical flow path 40a which is made to extend upwards along the center axis C of the piston from a center of a lower surface 38a of the piston 38 and horizontal flow paths 40b which extend from center side end portions 39a of the respective accommodating recessed portions 39 towards the center of the piston 38 in such a manner as to communicate with the vertical flow path 40a. Namely, the flow path 40 of the embodiment is made up of the single vertical flow path 40a which is made to open at a lower end thereof and is formed to extend along the center axis C of the piston 38 and four horizontal flow paths 40b which extend in all directions from an upper end of the vertical flow path 40a while intersecting the vertical flow path 40a at right angles in such a manner as to communicate with the accommodating recessed portions 39, respectively. In addition, in the case of the embodiment, an inside diametrical dimension D6 of the horizontal path 40b is set smaller than an inside diametrical dimension D5 of the vertical flow path 40a (refer to FIGS. 8, 9). Specifically, a difference or drop in diameter level 39b relative to the center side end portion 39a of the accommodating recessed portion 39 is provided along a whole circumferential area of the horizontal flow path 40b so that the inside diametrical dimension of the horizontal flow path 40b is made to be reduced relative to the accommodating recessed portion 39. In addition, in the case of the embodiment, this drop in diameter level 39b constitutes a movement preventing wall portion for preventing the locking pin 43 accommodated in the accommodating recessed portion 39 from moving towards the center of the piston 38.

In addition, an O-ring 41 is provided on an outer circumferential surface of the piston 38 at a portion in the vicinity of a lower end thereof which lies below the accommodating recessed portion 39 for preventing a leakage of the gas from between the sliding portion 23 and the piston 38 by being brought into press contact with an inner circumferential surface 23a of the sliding portion 23.

The locking pin 43 makes up, together with the stepped surface 24a (the locking surface 25) of the cylinder 21 and the flow path 40 in the piston 38, the locking mechanism R for restricting a reverse movement (a descending movement in the embodiment) of the supporting rod 45 which has moved forwards (moved upwards in the embodiment). In the case of the embodiment, the locking pin 43 is accommodated within the piston 38 while being restricted from a movement along the axial direction of the piston 38. Specifically, the locking pin 43 is accommodated within the accommodating recessed portion 39 in such a manner as to lie along the direction which intersects the axis of the piston 38 at right angles. In addition, the locking pins 43 are provided in the four positions which lie in a radial fashion about the center axis C of the piston in such a manner as to be disposed at substantially equal intervals along the direction extending around the axis of the piston 38. Each locking pin 43 is made into a substantially circular cylindrical shape and has an outside diametrical dimension which allows the locking pin 43 to slide along an inner circumferential surface of the accommodating recessed portion 39. A length dimension L1 (refer to FIG. 9A) of the locking pin 43 is made smaller than a radius D8 of the piston 38 and is set to such a dimension that a proximal portion 43a side of the locking pin 43 can be left accommodated within the accommodating recessed portion 39 when a distal end face 43c of the locking pin 43 is brought into abutment with an inner circumferential surface 24b of the large diameter portion 24 after the piston 38 has moved upwards. When the locking pin 43 comes to be disposed in the location where the large diameter portion 24 exists after the piston 38 has moved upwards, the locking pin 43 receives the pressure of the gas G which has flowed into the accommodating recessed portion 39 via the flow path 40 and projects momentarily in the direction which intersects the axis of the piston 38 at right angles from the accommodating recessed portion 39 (refer to FIGS. 8B, 9B). Then, in the locking pin 43 which has projected from the accommodating recessed portion 39, the distal end face 43c is brought into abutment with the inner circumferential surface 24b of the large diameter portion 24 with the proximal portion 43a side thereof left accommodated within the accommodating recessed portion 39. Namely, the locking pin 43 projecting from the accommodating recessed portion 39 is disposed in such a manner as to straddle between the locking surface 25 and the accommodating recessed portion 39 with the lower surface side (the side facing in the direction in which the piston descends) of the distal end portion 43b locked on the locking surface, whereby the descending movement of the piston 38 is restricted.

The supporting rod 45 includes the cylindrical head portion 45a at an upper end of the shaft portion 45b. When the supporting rod 45 moves upwards, the cylindrical head portion 45a is brought into abutment with the receiving seat 47 provided on the mounting bracket 20 at the rear end 15c of the hood panel 15 to thereby push up the rear end 15c of the hood panel 15. The supporting rod 45 is made of a metal material which can plastically be deformed, and in the case of the embodiment, the supporting rod 45 is formed integrally with the piston 38.

In the pedestrian protection system M of the embodiment, when the activation circuit, not shown, detects or predicts a collision of the vehicle V with a pedestrian based on signals from the sensors 6, the gas generators 35 in the actuators A of the respective uplift units U are activated and the inflators 11 of the respective air bag units 9 are also activated.

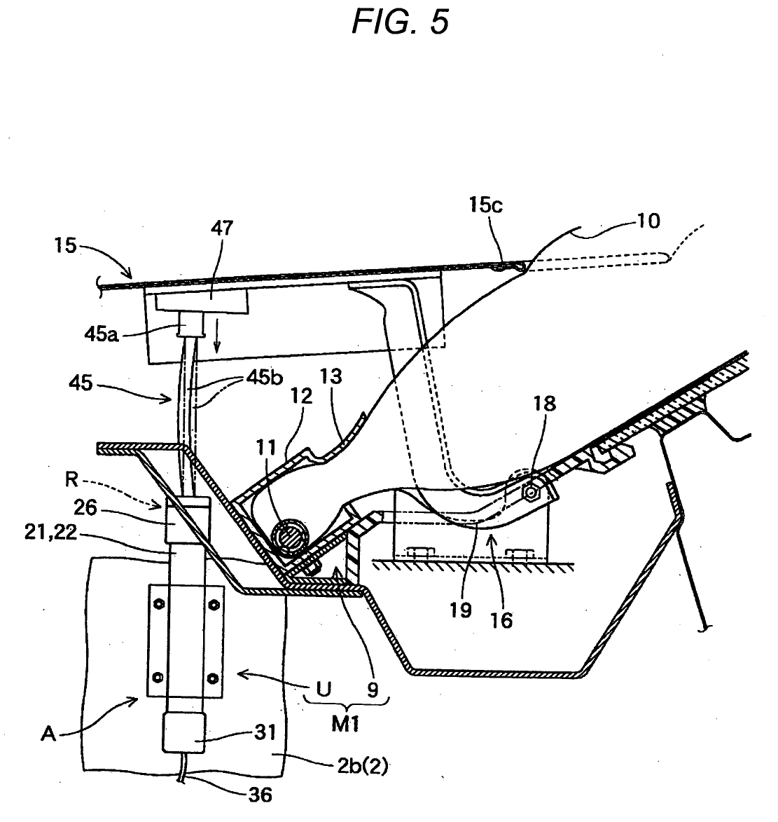

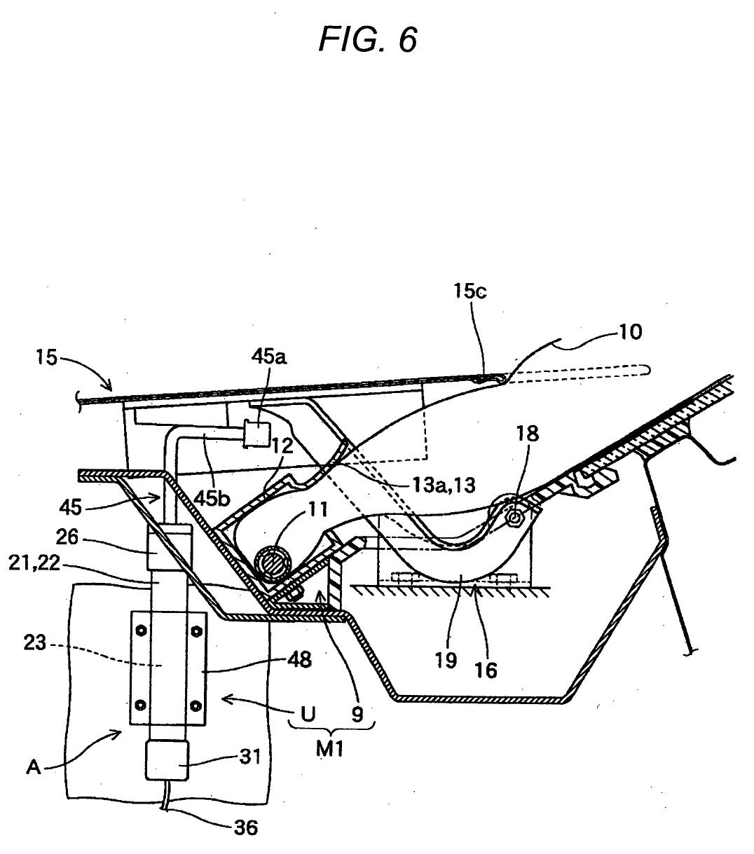

Then, when the gas generator 35 of the actuator A is activated, as is shown in FIG. 7, the piston 38 within the main body 22 of the cylinder 21 is pushed up by a gas G generated by the gas generator 35, and the head portion 45a at the upper end of the supporting rod 45 is brought into abutment with the receiving seat 47 to thereby cause the rear end 15c of the hood panel 15 to be uplifted, whereby a space S is formed on a rear end 15c side of the hood panel 15 between the hood panel 15 and the cowl 7. In addition, when the inflator 11 of the air bag unit 9 is activated, as is shown by chain double-dashed lines in FIGS. 1, 2 and FIG. 4, a gas is introduced into the air bag 10 which is folded from the inflator 11, and the air bag 10 push opens the door portion 13a of the air bag cover 13 and projects from the case 12, then, passes through the space S and is inflated in such a manner as to project towards an upper side of the windshield 3. The air bag 10, which has fully inflated, comes to cover a front side of the front pillar 4. Thereafter, when the hood panel 15 acting as the receiving member receives the pedestrian, the supporting rod 45 is plastically deformed in such a manner as to absorb the kinetic energy of the pedestrian in such a state that the supporting rod 45 is restricted from moving downwards (refer to FIGS. 5, 6).

In addition, in the actuator A of the embodiment, when a gas G is generated from the gas generator 35 as a result of the actuator A being activated, the gas G (the working fluid) flows into the cylinder 21 to fill it, and the lower surface 38a side of the piston 38 accommodated within the cylinder 21 is pushed by the gas G, whereby the piston 38 moves upwards together with the supporting rod 45. As this occurs, in the actuator A of the embodiment, the gas G flows into the accommodating recessed portions 39 (the accommodating portion) where the locking pins 43 are accommodated via the flow path 40 provided in the piston 38 at the same time as the piston 38 is pushed by the gas G, whereby having received the pressure of the gas G, the locking pins 43 are brought into press contact with the inner circumferential surface 23a side of the sliding portion 23 in such a manner that the distal end faces 43c thereof are brought into sliding contact with the inner circumferential surface of the cylinder 21 (the inner circumferential surface 23a of the sliding portion 23) at all times. Thus, the piston 38 moves upwards together with the supporting rod 45 in this state. Thereafter, when the piston 38 continues to move upwards until the locking pins 43 accommodated in the piston 38 are disposed in the positions confronting the locking surface 25 which is provided on the inner circumferential surface of the cylinder 21, that is until the locking pins 43 are disposed in the location on the main body 22 of the cylinder 21 where the large diameter portion 24 is formed, the locking pins 43 are caused to project from the corresponding accommodating recessed portions 39 momentarily the locking pins 43 receive the pressure of the gas G which has flowed into the accommodating recessed portions 39 where the locking pins 43 are accommodated via the flow path 40, whereby the lower surface sides of the distal end portions 43b of the locking pins 43 are locked on the locking surface 25 in such a manner that the distal end faces 43c thereof are brought into abutment with the inner circumferential surface 24b of the large diameter portion 24. Then, since the locking pins 43 are disposed in such manner as to straddle between the accommodating recessed portions 39 and the locking surface 25 while being restricted from the movement along the axial direction of the piston 38 with the proximal portions 43a left accommodated within the accommodating recessed portions 39, the descending movement (the reverse movement) of the supporting rod 45 which has moved upwards (moved forwards) can be restricted. Because of this, when the hood panel 15 acting as the receiving member receives a pedestrian as an object to be protected after the supporting rods 45 have moved upwards, the supporting rods 45 are made to be plastically deformed, thereby making it possible to absorb the kinetic energy of the pedestrian. Furthermore, in the actuator A of the embodiment, since the locking mechanism R for restricting the descending movement of the supporting rod 45 which has moved upwards is made up of the locking pins 43 which are accommodated within the accommodating recessed portions 39 and the locking surface 25 which is formed on the inner circumferential surface of the cylinder 21, the locking mechanism R is provided in such a manner as not to project outwards from the cylinder 21, and the actuator A can be made into the substantially circular cylindrical shape, whereby the actuator A can be fabricated compact.

Consequently, in the actuator A of the embodiment, even though the actuator A includes the locking mechanism R for preventing the reverse movement (the descending movement) of the supporting rod 45 after it has been activated, the actuator A can be fabricated compact.

in addition, in the actuator A of the embodiment, since the locking pins 43 are made to be pushed to move by making use of the gas G which is used to move the piston 38, the necessity can be obviated of separately providing a driving source for activating the locking mechanism R, whereby the complication of the configuration of the actuator A can be suppressed, and hence, an increase in number of parts involved can be prevented.

Furthermore, in the actuator A of the embodiment, the large diameter portion 24 which is made larger in diameter than the sliding portion 23 is provided in the cylinder 21, and the stepped surface from the sliding portion 23 at the large diameter portion 24 is made as the locking surface 25. Because of this configuration, the fabrication of the locking surface 25 is preferably facilitated, compared with a case where recessed portions through which the locking pins can pass are provided on the inner circumferential surface of the cylinder.

In addition, in the actuator A of the embodiment, since the locking pins 43 are provided in the four locations which are disposed radially about the center axis of the piston 38 in such a manner as to be disposed at substantially equal intervals on the outer circumferential surface of the piston 38 along the direction extending around the axis thereof, the locking pins 43 are allowed to be locked on the locking surface 25 over the whole area thereof along a direction extending around an axis of the cylinder 21, whereby the projecting state of the supporting rod 45 can preferably be stabilized. Of course, in case such a point is not taken into consideration, a configuration may be adopted in which only one locking pin is provided. In addition, although the number of locking pins is not limited to four, provided that there are provided a plurality of locking pins, in consideration of the stability of the projecting state of the supporting rod 45 and fabrication costs, it is desirable that three to four locking pins are provided.

Furthermore, in the actuator A of the embodiment, since the accommodating recessed portion 39 includes the difference or reduction in diameter 39b which acts as the movement preventing wall portion for preventing the movement of the locking pin 43 towards the center of the piston 38, the locking pin 43 can preferably be prevented from moving towards the center of the piston 38 more than required. Of course, in case such a point is not taken into consideration, a configuration may be adopted in which no difference or reduction in diameter is provided in the accommodating recessed portion by making substantially identical the inside diametrical dimensions of the accommodating recessed portion and the horizontal flow path of the flow path.

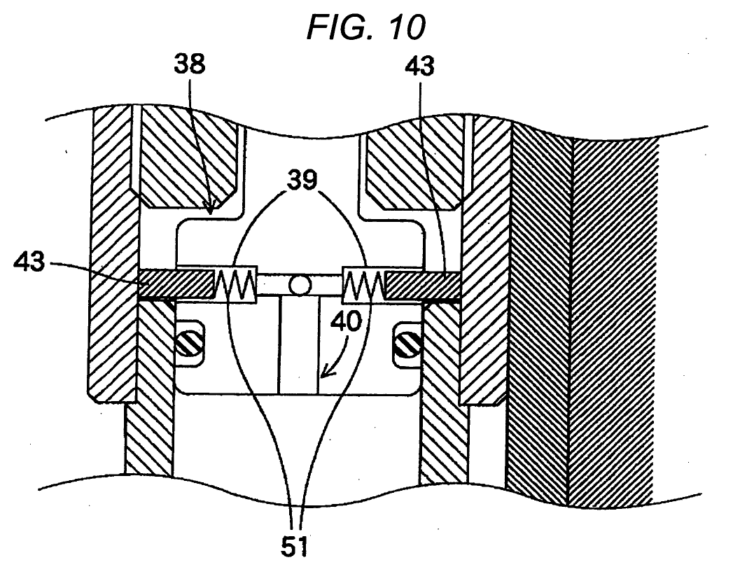

In addition, although not provided in the actuator A of the embodiment, as is shown in FIG. 10, a configuration may be adopted in which a return preventive means for preventing the return of the locking pin that has projected is provided on the circumference of the locking pin in the accommodating recessed portion. Namely, a configuration may be adopted in which a coil spring (the biasing means) 51 for biasing the locking pin 43 in the projecting direction is provided as a return preventive means between the locking pin 43 and the reduction in diameter 39b in the accommodating recessed portion 39. By adopting the configuration, even though the locking pin 43 that has projected from the accommodating recessed portion 39 is brought into striking abutment with the inner circumferential surface of the cylinder 21 to thereby receive a reaction force which attempts to return the locking pin 43 into the accommodating recessed portion 39, the locking pin 43 can be prevented from returning into the accommodating recessed portion 39, whereby the projecting state of the locking pin 43 can preferably be maintained stable. Of course, in case such a point is not taken into consideration, as described in the embodiment, the configuration may be adopted in which no such return preventive means is provided. In addition, the return preventive means is not limited to the biasing means such as the restorable coil spring, and hence, for example, a configuration may be adopted in which a return preventive means is made up of a linear material which can plastically be deformed in such a manner as to maintain a shape resulting after deformation so as to maintain the projecting state of the locking pin after it has received the pressure of the gas which attempts to cause the locking pin to project.

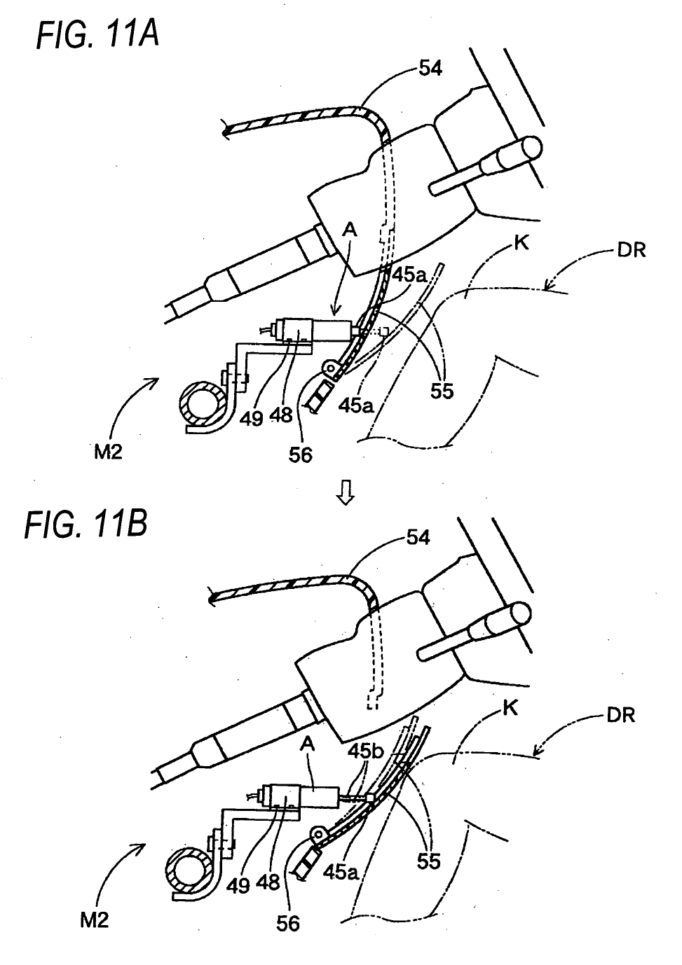

In addition, in the actuator A of the embodiment, while the forward movement is described as the ascending movement and the reverse movement as the descending movement, the operating directions of the actuator are not limited thereto, and hence, the actuator of the invention may be used in a direction in which the actuator operates in a horizontal direction, and the actuator of the invention may be used in other automotive safety systems than the pedestrian protection system M1. For example, the actuator A may be used in a knee protection system M2 as an automotive projection system shown in FIG. 11.

This knee protection system M2 is a system for protecting the knees K of the driver DR by receiving the knees K of the driver DR as an object to be protected. When the vehicle is involved in a frontal collision, the actuator A is activated so as to push out a knee receiving member 55 provided in an instrument panel 54 towards the rear, and when the knees K move forwards to collide with the knee receiving member 55, the shaft portion 45 of the supporting rod 45 is made to be plastically deformed so as to absorb the kinetic energy of the driver DR while receiving the knees K. In addition, the knee receiving member 55 is rotatably supported on a hinge portion 56 attached to the instrument panel 54 at a lower end 55b side thereof, and when the actuator A is activated, an upper end 55a is pushed out towards the rear about the hinge portion 56 which acts as a center of the rotation of the knee receiving member 55.

In addition, in the actuator A of the embodiment, the gas G generated from the gas generator 35 is used as the working fluid which is allowed to flow into the cylinder 21, so as to cause the piston to move forwards. Namely, in the actuator A of the embodiment, since the micro gas generator which can generate a gas rapidly in an explosive fashion when it is ignited can be used as the gas generator 35, the piston 38 can be moved quickly. Of course, in case such a point is not taken into consideration, water, oil or air can be used as the working fluid which is allowed to flow into the cylinder 21, so that the piston can be made to be moved by making use of water pressure, hydraulic pressure or pneumatic pressure produced by those fluids.

Furthermore, in the actuator A of the embodiment, while the piston 38 and the supporting rod 45 are made integral with each other, the supporting rod 45 and the piston 38 may of course be provided as separate units. In the case of the supporting rod being separated from the piston, by changing the outside diametric dimension of the shaft portion of the supporting rod, the absorption amount by which the kinetic energy of the object to be protected can easily be changed, and hence, the change in design is preferably facilitated.

What is claimed is:

1. An actuator adapted to be used in an automotive safety system, and configured as a piston cylinder type in which a piston disposed in a tubular cylinder is moved together with a supporting rod connected to the piston by introducing a working fluid into the cylinder, the actuator comprising:
a locking mechanism restricting a reverse movement of the supporting rod which has moved forwards, and
wherein the supporting rod which projects from a distal end wall portion of the cylinder is connected to a receiving member for receiving an object to be protected;
the supporting rod is provided in such a manner as to be plastically deformed so as to absorb kinetic energy of the object to be protected when the receiving member receives the object to be protected after the supporting rod has moved forwards;
wherein the locking mechanism comprises:
a locking pin adapted to be accommodated and held within the piston while being restricted from a movement along an axial direction of the piston when the locking pin moves forwards such that a distal end portion side of the locking pin projects along a direction which intersects the axial direction of the piston at right angles from an outer circumferential surface of the piston which extends around an axis of the piston with a proximal portion side thereof accommodated within the piston;
a flow path formed in the piston in such a manner as to allow the working fluid which flows into the cylinder to flow as far as an accommodating portion where the proximal portion side of the locking pin is accommodated; and
a locking surface provided in a position on an inner circumferential surface of the cylinder where the piston is disposed after the piston has moved forwards and adapted to lock the locking pin which is caused to project from the piston at the distal end portion side thereof so as to restrict a reverse movement of the supporting rod, and
when in an operation, the proximal end portion side of the locking pin is moved so as to project from the outer circumferential surface of the piston by a pressure produced by the working fluid which has been allowed to flow into the accommodating portion of the locking pin via the flow path.

2. The actuator as set forth in claim 1, wherein, in the cylinder, a large diameter portion which is made larger in diameter than a sliding portion along which the piston slides when it moves forwards is provided in a position where the locking pin projects after the piston has moved forwards, and wherein
a stepped surface from the sliding portion at the large diameter portion is made as the locking surface.

3. The actuator as set forth in claim 1, wherein the locking pin is provided at a plurality of portions which are disposed at substantially equal intervals along the direction extending around the axis of the piston.

4. The actuator as set forth in claim 1, wherein a movement preventing wall for preventing a movement of the locking pin towards a center of the piston is formed at the accommodating portion.

5. The actuator as set forth in claim 1, wherein a return preventive member for preventing a return of the projecting locking pin is provided on a circumference of the locking pin in the accommodating portion.
